(19) United States
(12) Patent Application Publication
(10) Pub. No.: US 2014/0156408 A1
(43) Pub. Date: Jun. 5, 2014

(54) MEMBER REGISTRATION SYSTEM, MEMBER REGISTRATION APPARATUS, AND MEMBER REGISTRATION METHOD

(71) Applicant: YAHOO JAPAN CORPORATION, Tokyo (JP)

(72) Inventor: Naomi OTOMO, Tokyo (JP)

(73) Assignee: YAHOO JAPAN CORPORATION, Tokyo (JP)

(21) Appl. No.: 14/093,886

(22) Filed: Dec. 2, 2013

(30) Foreign Application Priority Data
Dec. 4, 2012 (JP) 2012-265553

(51) Int. Cl. G06Q 30/02

(52) U.S. Cl. CPC G06Q 30/0258
USPC 705/14.56

(57) ABSTRACT

A member registration system according to an embodiment includes an information processing apparatus that performs an enrollment process in a member service of a store in which a wireless communication apparatus is installed. The information processing apparatus includes a detection unit that detects a wireless terminal present within a communication area of the wireless communication apparatus, a determination unit that determines whether enrollment of a user of the wireless terminal detected by the detection unit in the member service is completed based on information stored in a member database, and a setting unit that registers information on the user of the wireless terminal as member information of the member service in the member database, when the user of the wireless terminal for which the determination unit determines that the enrollment in the member service is not completed is a user satisfying a preset enrollment condition.

### CROSS-REFERENCE TO RELATED APPLICATIONS

The present application claims priority to and incorporates by reference the entire contents of Japanese Patent Application No. 2012-265553 filed in Japan on Dec. 4, 2012.

### BACKGROUND OF THE INVENTION

1. Field of the Invention

The present invention relates to a member registration system, a member registration apparatus, and a member registration method.

2. Description of the Related Art

In the related art, a method of providing a member service such as a loyalty program or a stamp service has been known as one of promotion methods at stores. In the member service, for example, a user who is a member fills up user information such as a name or a sex in a register or the like of a store and the store side issues a member card such as a loyalty card or a stamp card.

When the store side issues the member card, a process of registering user information in a member database is necessary and thus this process is cumbersome. Accordingly, Japanese Laid-open Patent Publication No. 2007-148696 suggests a technology for performing member registration by inputting user information to a point input terminal.

In the technology disclosed in Japanese Laid-open Patent Publication No. 2007-148696, however, the member is not registered unless a user inputs information to the point input terminal. Therefore, a load is imposed on the user, and thus there is a concern that promotion at a store is not sufficiently achieved.

### SUMMARY OF THE INVENTION

According to an exemplary embodiment, a member registration system includes a wireless communication apparatus, an information processing apparatus, and a member database. The information processing apparatus performs a process of enrollment in a member service of a store in which the wireless communication apparatus is installed. The member database stores member information of the member service. The information processing apparatus includes a detection unit, a determination unit, and a setting unit. The detection unit detects a wireless terminal present within a communication area of the wireless communication apparatus. The determination unit determines whether enrollment of a user of the wireless terminal detected by the detection unit in the member service is completed based on information stored in the member database. The setting unit registers information on the user of the wireless terminal as member information of the member service in the member database, when the user of the wireless terminal for which the determination unit determines that the enrollment is not completed is a user satisfying a preset enrollment condition.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a diagram illustrating the configuration of a member registration system according to an embodiment;

FIG. 1B is a diagram illustrating a sequence of a member registration process performed by the member registration system according to the embodiment;

FIG. 2 is a diagram illustrating an example of the configuration of the member registration system according to the embodiment;

FIGS. 3A and 3B are diagrams illustrating sequences of session establishment between a wireless LAN access point and a wireless terminal;

FIG. 4 is a diagram illustrating an example of a terminal information table;

FIG. 5 is a diagram illustrating an example of a member data table;

FIG. 6 is a diagram illustrating an example of a rank determination table;

FIG. 7 is a diagram illustrating an example of an interest degree determination table;

FIG. 8 is a diagram illustrating an example of a user information table;

FIGS. 9A to 9D are diagrams illustrating an example of a display screen of a member card application; and

FIG. 10 is a flowchart illustrating the member registration process performed by a member registration apparatus according to the embodiment.

### DETAILED DESCRIPTION OF THE PREFERRED EMBODIMENTS

Hereinafter, a member registration system, a member registration apparatus, and a member registration method according to the application of the present invention will be described in detail with reference to the drawings. An embodiment herein does not limit the member registration system, the member registration apparatus, and the member registration method according to the application of the present invention. Hereinafter, a database is referred to as a DB.

### 1. Member Registration Process

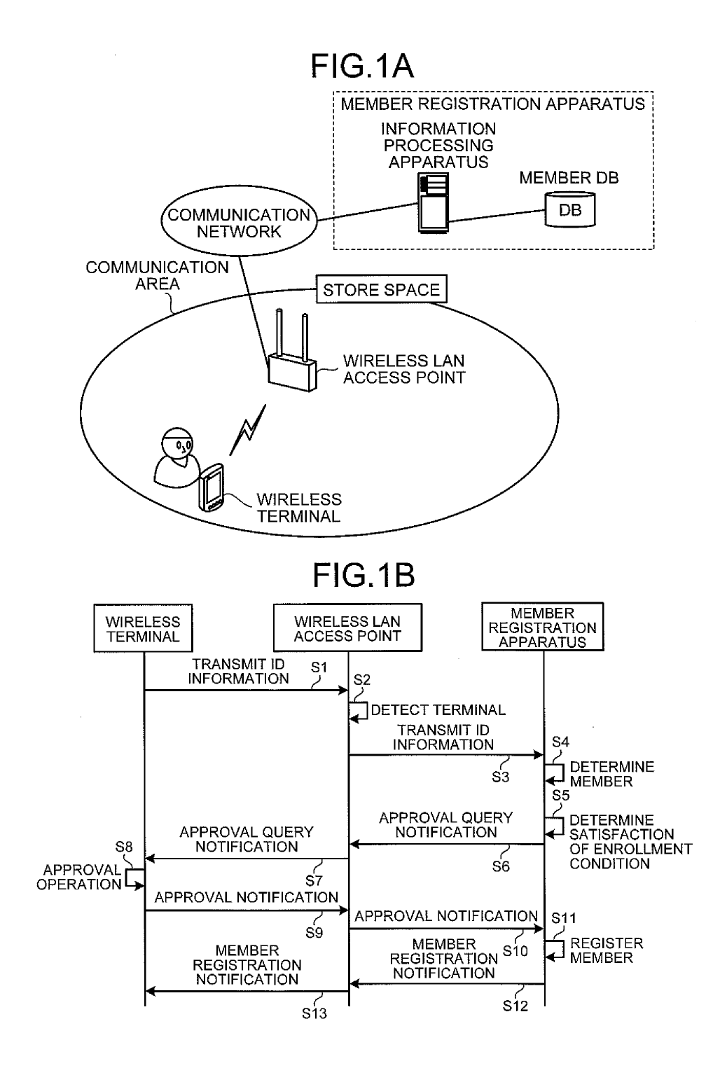

First, the configuration of a member registration system according to an embodiment will be described. FIG. 1A is a diagram illustrating the configuration of the member registration system according to the embodiment. As illustrated in FIG. 1A, the member registration system according to the embodiment includes a member registration apparatus and a wireless LAN access point.

The wireless LAN access point is installed in a store space and configures an area including the store space as a communication area (hereinafter referred to as an AP communication area). A wireless terminal having a wireless LAN function can perform wireless communication with the wireless LAN access point when the wireless terminal enters the AP communication area.

The wireless LAN access point can transmit and receive information to and from the member registration apparatus via a communication network and has, for example, a relay function of relaying the information transmitted and received between the wireless terminal and the member registration apparatus. The communication network is, for example, an internet protocol (IP) network such as the Internet.

The member registration apparatus includes an information processing apparatus that performs an enrollment process in a member service of a store (hereinafter referred to as an AP installation store) in which the wireless LAN access point is installed and a member DB that stores member information of the member service. The member registration apparatus dynamically performs the member registration of users of wireless terminals present within the AP communication area. Accordingly, the enrollment process in the member service provided by the store can be performed without user's time and effort.

FIG. 1B is a diagram illustrating a sequence of a member registration process performed by the member registration system according to the embodiment. As illustrated in FIG. 1B, a wireless terminal transmits ID information to the wireless LAN access point through wireless LAN communication when the wireless terminal enters the AP communication area (step S1). The ID information transmitted by the wireless terminal is, for example, identification information allocated to the wireless terminal or identification information allocated to the user of the wireless terminal.

The wireless LAN access point detects the wireless terminal having transmitted the ID information (step S2) and transmits the ID information, which has been transmitted from the wireless terminal, to the member registration apparatus via the communication network (step S3).

The member registration apparatus determines whether enrollment of the user of the wireless terminal entering the AP communication area in the member service is completed based on the ID information acquired from the wireless LAN access point (step S4). When the member information according to the ID information acquired from the wireless LAN access point is stored in the member DB, the member registration apparatus determines that the enrollment of the user of the wireless terminal in the member service is completed. Conversely, when the member information is not stored, the member registration apparatus determines that the user of the wireless terminal is not enrolled in the member service.

When the member registration apparatus determines that the user of the wireless terminal is not enrolled in the member service, the member registration apparatus determines whether the user of the wireless terminal satisfies an enrollment condition of the member service (step S5). The enrollment condition is a condition of an interest degree (hereinafter referred to as a degree of interest of user) of the user of the wireless terminal with respect to the AP installation store. Based on the degree of interest of user, the member registration apparatus determines whether the enrollment condition is satisfied.

For example, the member registration apparatus estimates the degree of interest of user with respect to the AP installation store based on a stay time of the user at the AP installation store, a store visit history of the user to the AP installation store, a purchase history of the user at the AP installation store, a passage history of the wireless terminal in the AP communication area, and the like.

When the user of the wireless terminal satisfies the enrollment condition in the member service, the member registration apparatus transmits a notification (hereinafter referred to as an approval query notification) to query approval of an enrollment process for the wireless terminal to the wireless terminal via the wireless LAN access point (steps S6 and S7). When the wireless terminal receives the approval query notification, the wireless terminal displays a screen used to select approval or disapproval of the enrollment process on a display unit (not illustrated).

When the user of the wireless terminal selects an approval button displayed on the screen of the display unit through an operation unit (not illustrated) (step S8), an approval notification is transmitted from the wireless terminal to the member registration apparatus via the wireless LAN access point (steps S9 and S10).

When the member registration apparatus receives the approval notification from the wireless terminal, the member registration apparatus registers information (hereinafter also referred to as terminal user information in some cases) on the user of the wireless terminal as member information of the member service in the member DB (step S11). For example, the terminal user information can be acquired from an external information management apparatus or the wireless terminal.

For example, the member registration apparatus acquires the terminal user information from the external information management apparatus by transmitting an information transmission request including the ID information, which has been transmitted from the wireless terminal, to the information management apparatus. Also, for example, the member registration apparatus acquires the terminal user information from the wireless terminal by transmitting a user information transmission request to the wireless terminal.

Next, the member registration apparatus transmits a member registration notification which is a notification indicating member registration to the wireless terminal via the wireless LAN access point (steps S12 and S13). Also, the member registration apparatus can also cause a member card issuing apparatus installed in the store to issue a member card by transmitting a member ID to the member card issuing apparatus.

In this way, the member registration system according to the embodiment registers information on the user of the wireless terminal entering the AP communication area as member information of the member service in the member DB. Therefore, the enrollment process in the member service can be performed without user's time and effort and it is not necessary that the store side manually register the user information in the member DB.

Also, when the use of the wireless terminal satisfies a preset enrollment condition, the enrollment process is performed. Thus, reduction in a processing load or suppression of an increase in a DB capacity can be achieved compared to a case in which the enrollment process is performed every time on a wireless terminal entering the AP communication area. For example, by setting the degree of interest of user as the enrollment condition, the enrollment process is not performed on a user of wireless terminal who is less interested in the AP installation store. Therefore, the reduction in the processing load or the suppression of the increase in the DB capacity can be achieved.

For example, when enrollment approval in all of the member services is transmitted from the wireless terminal to the member registration apparatus in advance and the user of the wireless terminal satisfies the enrollment condition in the member service, the member registration apparatus can also perform the enrollment process without transmitting an approval query notification.

### 2. Configuration of Member Registration System

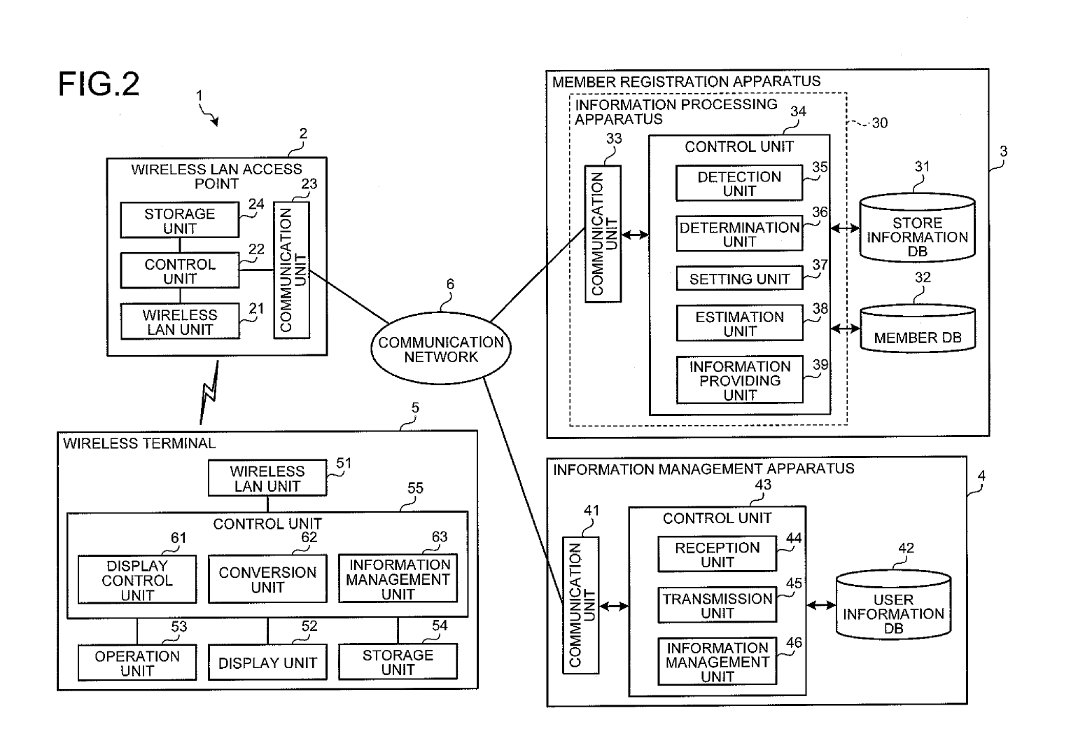

An example of the configuration of the member registration system according to the embodiment will be described with reference to FIG. 2. FIG. 2 is a diagram illustrating an example of the configuration of the member registration system according to the embodiment.

As illustrated in FIG. 2, a member registration system 1 includes a wireless LAN access point 2, a member registration apparatus 3, and an information management apparatus 4. The wireless LAN access point 2 is an example of a wireless communication apparatus. The member registration system 1 performs a process of enrollment in a member service of a store (AP installation store) in which the wireless LAN access point 2 is installed with respect to a user of a wireless terminal 5.

The member services are, for example, various services such as a loyalty program, a stamp service, and a discount service. The loyalty program and the coupon service will be described below. The stamp service is, for example, a service that provides a free gift or a discount coupon when the number of stamps provided from the store side is a predetermined number. Also, the discount service is a service that provides discount of a product or a service to be provided.

The wireless terminal 5 is a mobile phone having a wireless LAN communication function, such as a smartphone. In the example of FIG. 2, only one wireless terminal 5 is illustrated, but the wireless terminals 5 belongs to each user, respectively.

A member card application (hereinafter referred to as a member card app) is installed on the wireless terminal 5. For example, the wireless terminal 5 causes the member card application to be executable by acquiring data of a member card application program provided from the information management apparatus 4 via a communication network 6 and developing the member card application program data on an internal storage unit. Also, the member card application program corresponds to an example of a store member program.

The wireless LAN access point 2 and the member registration apparatus 3 are managed by, for example, a manager of a store and the information management apparatus 4 is managed by, for example, an information service provider who provides information. Also, the member registration apparatus 3 and the information management apparatus 4 may be managed by the information service provider.

2.1. Configuration of Wireless LAN Access Point 2

As illustrated in FIG. 2, the wireless LAN access point 2 includes a wireless LAN unit 21, a control unit 22, a communication unit 23, and a storage unit 24. The wireless LAN unit 21 transmits and receives information to and from the wireless terminal 5 on which a wireless LAN communication function is mounted. The communication unit 23 transmits and receives information to and from the communication network 6. Also, for example, a wireless LAN is a wireless LAN or the like defined in conformity with IEEE 802.11, but is not limited to a wireless LAN of this standard.

The control unit 22 performs an information relay process, a process of detecting the wireless terminal 5, and the like by controlling the wireless LAN access point 2. The information relay process is, for example, a process of transmitting information acquired from the wireless terminal 5 via the wireless LAN unit 21 to the member registration apparatus 3 via the communication unit 23 and a process of transmitting information acquired from the member registration apparatus 3 via the communication unit 23 to the wireless terminal 5 via the wireless LAN unit 21.

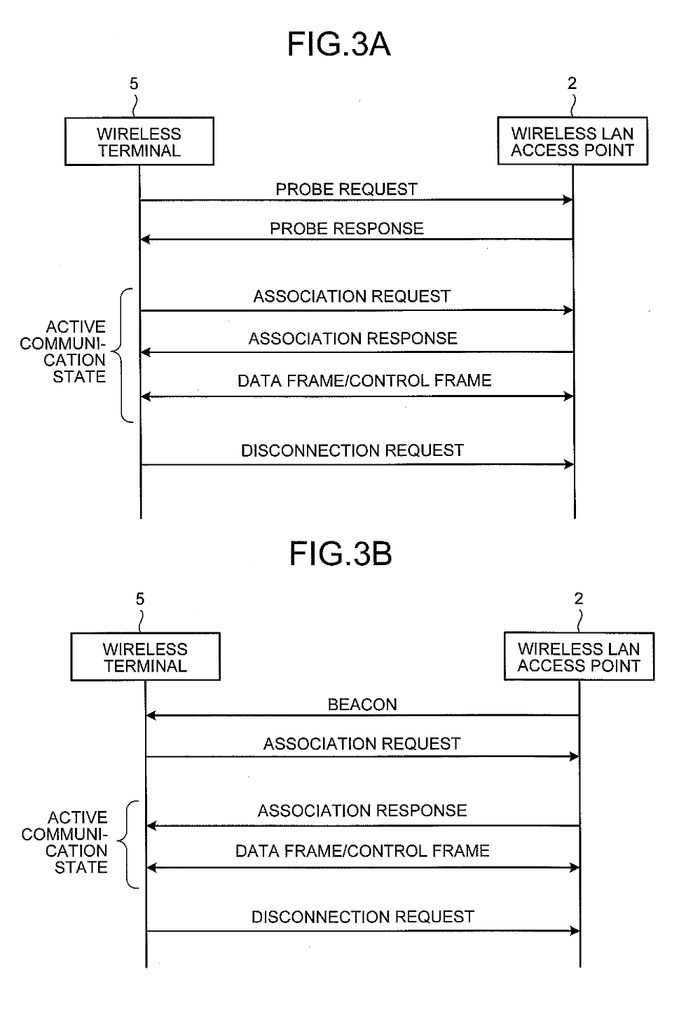

The process of detecting the wireless terminal 5 is a process of detecting existence of the wireless terminal 5 by acquiring wireless packets transmitted from the wireless terminal 5 via the wireless LAN unit 21. FIGS. 3A and 3B are diagrams illustrating sequences of session establishment between the wireless LAN access point 2 and the wireless terminal 5.

In the example illustrated in FIG. 3A, a wireless packet called a probe request is transmitted periodically by broadcast or the like from the wireless terminal 5, and thus the control unit 22 detects existence of the wireless terminal 5 by acquiring the wireless packet via the wireless LAN unit 21.

The probe request contains a basic service set identifier (BSSID). Therefore, the control unit 22 transmits a probe response to the wireless terminal 5, when the BSSID is identical to the BSSID of the wireless LAN unit 21. The control unit 22 receiving the probe response transits to an active communication state when automatic communication is set in the wireless terminal 5.

As illustrated in FIG. 3A, the transition to the active communication state is performed by establishing a session by an association request and an association response. Thereafter, the control unit 22 enters the communication-working state by transmitting and receiving a data frame or a control frame between the wireless terminal 5 and the wireless LAN unit 21.

Also, the active communication state is released when a disconnection request is given from the wireless terminal 5 or wireless packets cannot be transmitted and received between the wireless terminal 5 and the wireless LAN unit 21. When the control unit 22 transits to the active communication state, the control unit 22 receives the wireless packets repeatedly until the active communication state is released, and is in a state of detecting the existence of the wireless terminal 5.

The control unit 22 detects the existence of the wireless terminal 5 by broadcasting a wireless packet called a beacon to the wireless terminal 5 having not periodically transmitted the wireless packets via the wireless LAN unit 21 and receiving an association request to the beacon, for example, as illustrated in FIG. 3B.

The control unit 22 receiving the association request establishes a session by transmitting an association response to the wireless terminal 5 and sets an active communication state between the wireless terminal 5 and the wireless LAN unit 21. Also, when a disconnection request is given from the wireless terminal 5 or the wireless packets may not be transmitted and received between the wireless terminal 5 and the wireless LAN unit 21, the active communication state is released. In the case of the example illustrated in FIG. 3A, when the control unit 22 transits to the active communication state, the control unit 22 receives the wireless packets repeatedly thereafter until the release of the active communication state, and is in a state of detecting the existence of the wireless terminal 5.

For example, when the control unit 22 determines the detection of the wireless terminal 5, the control unit 22 transmits terminal information to the member registration apparatus 3 via the communication unit 23. Specifically, the control unit 22 extracts identification information (hereinafter referred to as a terminal ID) of the wireless terminal 5 contained in the wireless packet transmitted from the wireless terminal 5 and further detects a radio wave intensity of the wireless packet. The terminal ID is identification information (for example, the MAC address of a wireless LAN unit 51 of the wireless terminal 5), such as a MAC address, which is unique to the wireless terminal 5, is added to the wireless packet, and is transmitted from the wireless terminal 5.

Then, the control unit 22 transmits information including identification information of the self-wireless LAN unit 21 in addition to the terminal ID of the wireless terminal 5 and the information on the radio wave intensity as terminal information to the member registration apparatus 3. For example, an address allocated to the communication unit 23 can be used as the identification information of the wireless LAN unit 21.

The control unit 22 summarizes the identification information of the wireless terminal 5 detected for a predetermined period for each predetermined period and transmits the summarized identification information to the member registration apparatus 3. However, the control unit 22 can also transmit the identification information to the member registration apparatus 3 whenever the control unit 22 detects the identification information of the wireless terminal 5.

2.2. Configuration of Member Registration Apparatus 3

As illustrated in FIG. 2, the member registration apparatus 3 includes an information processing apparatus 30, a store information DB 31, and a member DB 32. The information processing apparatus 30 includes a communication unit 33 and a control unit 34. The control unit 34 includes a detection unit 35, a determination unit 36, a setting unit 37, an estimation unit 38, and an information providing unit 39.

The communication unit 33 is, for example, an interface such as a network interface card (NIC). The control unit 34 transmits and receives various kinds of information to and from the wireless LAN access point 2, the information management apparatus 4, and the wireless terminal 5 via the communication unit 33.

The store information DB 31 and the member DB 32 are, for example, storage devices such as hard disks, random access memory (RAM), semiconductor memory elements such as flash memory, or optical discs. The store information DB 31 stores various kinds of information on an AP installation store, as will be described below. Also, the member DB 32 stores member information on users enrolled in a member service of an AP installation store, as will be described below.

The control unit 34 is realized by, for example, an integrated circuit such as an application specific integrated circuit (ASIC) or a field programmable gate array (FPGA). Also, the control unit 34 functions as the detection unit 35, the determination unit 36, the setting unit 37, the estimation unit 38, and the information providing unit 39 when a central processing unit (CPU) or a micro processing unit (MPU) executes a program stored in an internal storage device using the RAM as a working area. The configuration of the control unit 34 is not limited to the above configuration. Another configuration may be used as long as information processing to be described below is performed.

Detection Unit 35

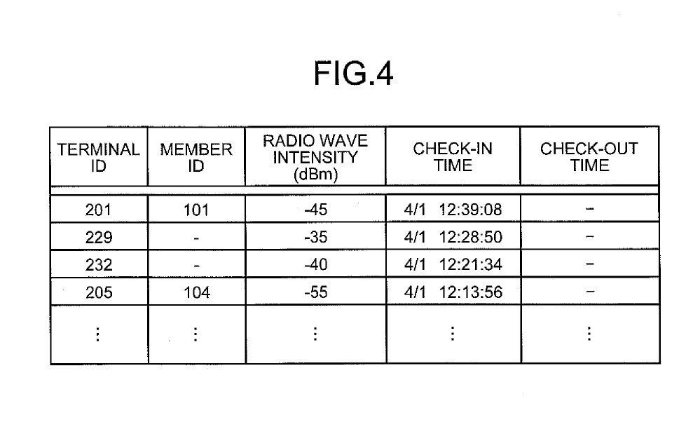

The detection unit 35 detects the wireless terminal 5 present within the AP communication area based on the terminal information transmitted from the wireless LAN access point 2. The detection unit 35 sets the received terminal information in a terminal information table of the store information DB 31 when the terminal information is received from the wireless LAN access point 2. FIG. 4 is a diagram illustrating an example of the terminal information table.

As illustrated in FIG. 4, the terminal information table includes information with which information such as a “member ID,” “radio wave intensity,” a “check-in time”, and a “check-out time” is associated for each “terminal ID.”

The “terminal ID” is a terminal ID of the wireless terminal 5 present within the AP communication area. For example, the example illustrated in FIG. 4 represents the wireless terminals 5 with terminal IDs “201,” “229,” “232,” “205”, and the like present within the communication area of the wireless LAN access point 2. The terminal ID is, for example, the MAC address of the wireless LAN unit 51 of the wireless terminal 5, but is represented simply as a 3-digit number in the example illustrated in FIG. 4.

The “member ID” is identification information allocated when the user of the wireless terminal 5 is enrolled in a member service. In the example illustrated in FIG. 4, the member ID is represented simply as a 3-digit number, but may be represented as a combination of characters, signs, and the like.

The “radio wave intensity” is information on the radio wave intensity of the wireless terminal 5 present within the AP communication area. In the example illustrated in FIG. 4, for convenience shake, information on the latest radio wave intensity is represented in correspondence with each terminal ID. However, information on a radio wave intensity from the time (hereinafter referred to as check-in) of the entrance of the wireless terminal 5 to the AP communication area is set in the terminal information table. Also, in the example illustrated in FIG. 4, a unit of the radio wave intensity is represented as “dBm,” but another unit may be set.

When the terminal information is received from the wireless LAN access point 2, the detection unit 35 sets the terminal ID and radio wave intensity information in the terminal information table. Also, when a member ID is received from the wireless terminal 5, the detection unit 35 sets the member ID in the terminal information table in correspondence with the terminal ID of the wireless terminal 5. Also, the control unit 34 can also set the member ID in the terminal information table based on information set in the member data table stored in the member DB 32.

The “check-in time” is an entrance time at which the wireless terminal 5 enters the AP communication area. By comparing the entrance time to a current time, it is possible to detect a stay time of the wireless terminal 5 within the communication area. The “check-out time” is a time at which the wireless terminal 5 exits from the communication area after the entrance to the AP communication area. In the example illustrated in FIG. 4, information on the wireless terminal 5 exiting from the AP communication area is not included. However, when the wireless terminal 5 entering the communication area exits from the communication area, an exit time is set as a check-out time in the terminal information table by the detection unit 35.

For example, a time at which the detection unit 35 does not receive the terminal information of the wireless terminal 5 entering the AP communication area and a predetermined time passes is referred to as a “check-out time” of the wireless terminal 5. Also, based on the terminal information, the detection unit 35 can also set a time at which the active communication state with the wireless terminal 5 is terminated as the “check-out time” of the wireless terminal 5.

When the detection unit 35 sets the “check-out time,” a set of the “terminal ID,” the “member ID,” the “check-in time,” the “check-out time,” and the “radio wave intensity” for which the “check-out time” is set is managed as history information in the store information DB 31.

The detection unit 35 detects a store visit history of the user of each wireless terminal 5 for the AP installation store or a stay time for the AP installation store based on the history information managed in the store information DB 31, and then updates information on the “store visit history” or the “stay time” of a member data table of the member DB 32 to be described below.

For example, when the number of times the user of a member ID “101” visits per month is “4,” the detection unit 35 sets the “store visit history” corresponding to the member ID “101” to “4” based on the history information managed in the store information DB 31, as illustrated in FIG. 5 to be described below.

The detection unit 35 can set the fact that the stay time in the AP installation store and the radio wave intensity are equal to or greater than predetermined threshold values, as a count condition of the number of store visits. For example, when the stay time is equal to or greater than 3 minutes and the average of the radio wave intensities is equal to or greater than −40 dBm, the detection unit 35 determines that the user visits the store. Also, the threshold values used for count the number of store visits can be set for each member ID. The threshold values can also be changed according to, for example, whether the member is male or female.

When the user of the member ID “103” stays within the AP communication area for 12 minutes, the detection unit 35 sets the “stay time” corresponding to the member ID “103” to “12” based on the terminal information table managed in the store information DB 31, as illustrated in FIG. 5 to be described below. Also, “0” is set as the “stay time” corresponding to a member ID of a user not staying within the AP communication area.

When the number of times the user of a member ID “102” passes through the AP communication area is “10” per month, the detection unit 35 sets the “passage history” corresponding to the member ID “102” to “10” based on the history information managed in the store information DB 31, as illustrated in FIG. 5 to be described below.

The detection unit 35 can set the fact that the stay time within the AP installation store and/or the radio wave intensity are in predetermined ranges, as a count condition of the number of passages. For example, when the stay time is in the range of 2 seconds to 10 seconds and/or the average of the radio wave intensities is in the range of −60 dBm to −55 dBm, the detection unit 35 determines that the user passes through the AP communication area. Also, the range in which the number of passages is counted can be set for each member ID. The range can also be changed according to whether the member is male or female.

Determination Unit 36

Based on the member information stored in the member DB 32, the determination unit 36 determines whether the enrollment of the user of the wireless terminal 5 detected by the detection unit 35 in the member service is completed.

When the member information included in the terminal ID of the wireless terminal 5 is set in the member data table of the member DB 32, the determination unit 36 determines that the enrollment of the user of the wireless terminal 5 in the member service is completed. Conversely, when the member information included in the terminal ID of the wireless terminal 5 is not set in the member data table of the member DB 32, the determination unit 36 determines that the user of the wireless terminal 5 does not enroll in the member service.

When a member ID is transmitted from the wireless terminal 5 and the member information including the member ID is set in the member data table of the member DB 32, the determination unit 36 determines that the enrollment of the user of the wireless terminal 5 in the member service is completed. Conversely, when the member information including the member ID transmitted from the wireless terminal 5 is not set in the member data table of the member DB 32, the determination unit 36 determines that the user of the wireless terminal 5 does not enroll in the member service.

FIG. 5 is a diagram illustrating an example the member data table stored in the member DB 32. As illustrated in FIG. 5, the member data table includes information with which information such as a “terminal ID,” a “point”, a “member rank,” a “purchase price,” a “store visit history,” a “stay time,” a “passage history,” and a “user attribute,” is associated for each “member ID.”

The “point” is given, for example, when a user purchases a product or a service within the AP installation store. A point of a predetermined ratio is granted to a purchase price of the product or the service. For example, when the user of a member ID “104” purchases a product of “2,000 yen,” “20” which is 1% of the purchase price of the product is granted as a point, as illustrated in FIG. 5.

When the member ID and the purchase price are input to a store terminal (not illustrated) connected to the communication network 6, the granting of the point is transmitted from the store terminal to the member registration apparatus 3 and is set in the member data table by the setting unit 37 to be described below.

The member ID is input by a barcode reader connected to the store terminal. Further, when the wireless terminal 5 transmits the member ID through near field communication (NFC), the member ID is received by an NFC device connected to the store terminal and is set in the member data table.

An NFC communication area is a communication area of about several centimeters to one meter. Examples of the NFC include Felica, ISO/IEC 14443 (MIFARE), and the like. Further, the communication by the NFC is not limited to a radio wave. For example, infrared communication, visible ray communication, an acoustic wave can also be used.

The “member rank” is information indicating a grade of a member service and is set for each member ID. The member rank is set and updated by the setting unit 37 to be described below. Here, five stages of “S” and “A” to “D” will be described, but six or more stages may be used and four or less stages may be used.

The “purchase price” is information updated when a user purchases a product or a service within the AP installation store and indicates a sum of purchase prices of products or services for each member. For example, in the example illustrated in FIG. 5, a sum of the purchase prices of the products and the services of the user of the member ID “201” is “50,000 yen.” The purchase price is set and updated in the member data table when the member ID and the purchase price are input to the store terminal (not illustrated), as described above.

The “store visit history” is information indicating the number of store visits per month and is set for each member ID. Here, when the number of store visits per month is used as the store visit history, but is merely an example. The number of store visits per week, the number of store visits within one year, or the like may be used.

The “stay time” is information indicating a time during which the user stays within the AP communication area and is set for each member ID. Further, “0” is set to the “stay time” corresponding to the member ID of a user not present within the AP communication area.

The “passage history” is information indicating the number of times that the user passes through the AP communication area per month and is set for each member ID. Here, the passage history is set to the number of passages per month, but is merely an example. The number of passages per week, the number of passages within one year, or the like may be used.

The “user attribute” is information indicating a user attribute of a member and is information on a sex, an age, a name, an address, or a preference in the example illustrated in FIG. 5. Further, information indicating user's values, lifestyle, personality, or the like may be included in the “user attribute.”

Setting Unit 37

The setting unit 37 transmits an approval query notification to the wireless terminal 5 when the user of the wireless terminal 5 for which the determination unit 36 determines that the enrollment in the member service is not completed is the user satisfying a preset enrollment condition. When the setting unit 37 receives an approval notification in response to the approval query notification from the wireless terminal 5, the setting unit 37 registers information on the user of the wireless terminal 5 as member information of the member service in the member DB 32. Further, when the setting unit 37 does not receive the approval notification for the approval query notification from the wireless terminal 5 or receives an approval rejection notification, the setting unit 37 does not perform the enrollment process.

The setting unit 37 sets a degree of interest of user estimated by the estimation unit 38 to be described below as an enrollment condition. The degree of interest of user is estimated based on the number of store visits, the stay time, the number of passages, the purchase price, and the like by the estimation unit 38.

When the degree of interest of user estimated by the estimation unit 38 satisfies the enrollment condition, the setting unit 37 registers the information on the user of the wireless terminal 5 as member information of the member service in the member data table of the member DB 32.

Specifically, the setting unit 37 requests the information management apparatus 4 to transmit attribute information of the user of the wireless terminal 5 via the communication unit 33 and the communication network 6. Since the terminal ID of the wireless terminal 5 is included in the request, the information management apparatus 4 acquires the attribute information corresponding to the terminal ID from a user information DB 42 and transmits the acquired attribute information to the member registration apparatus 3, as will be described below.

When the attribute information of the user of the wireless terminal 5 is acquired from the information management apparatus 4, the setting unit 37 sets the acquired attribute information to the “user attribute” of the member data table. Accordingly, the attribute information of which the degree of interest of user satisfies the enrollment condition is set in the member data table.

The setting unit 37 allocates a new member ID to the user of the wireless terminal 5 and sets the allocated member ID in the member data table along with the terminal ID of the wireless terminal 5. Further, the setting unit 37 allocates a member rank to the user of the wireless terminal 5 and sets the allocated member rank in the member data table. Accordingly, the “member ID,” the “terminal ID,” the “member rank,” and the “user attribute” are set in the member data table, and the enrollment process for the user of the wireless terminal 5 is completed.

“D” is allocated as a member rank to a user who becomes a new member, but the rank may be set based on a purchase price, a store visit history, a stay time, a passage history, and the like. In this case, the member registration apparatus 3 can provide a terminal user table in which a purchase price, a store visit history, a stay time, and a passage history are associated with a terminal ID and set a rank based on the terminal user table. Further, the member data table may be used instead of the terminal user table. In this case, information in which the member ID is not set is also set, but the table can be shared.

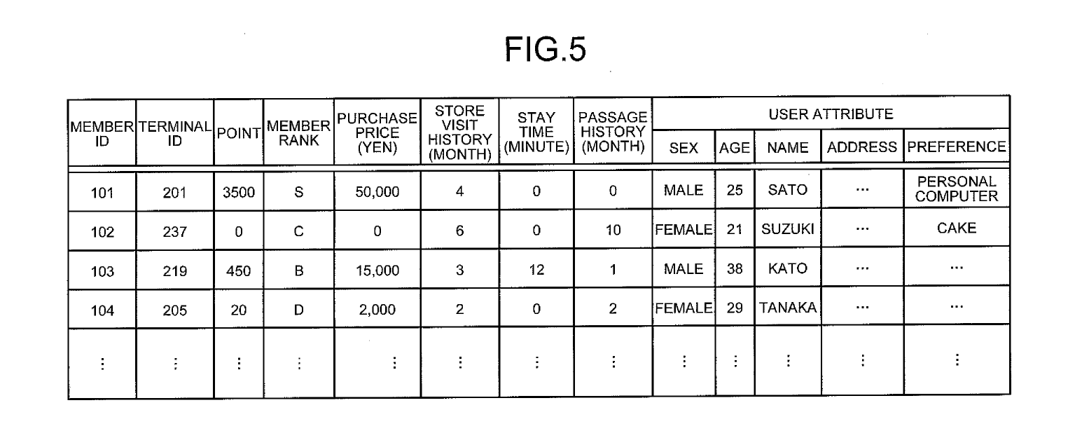

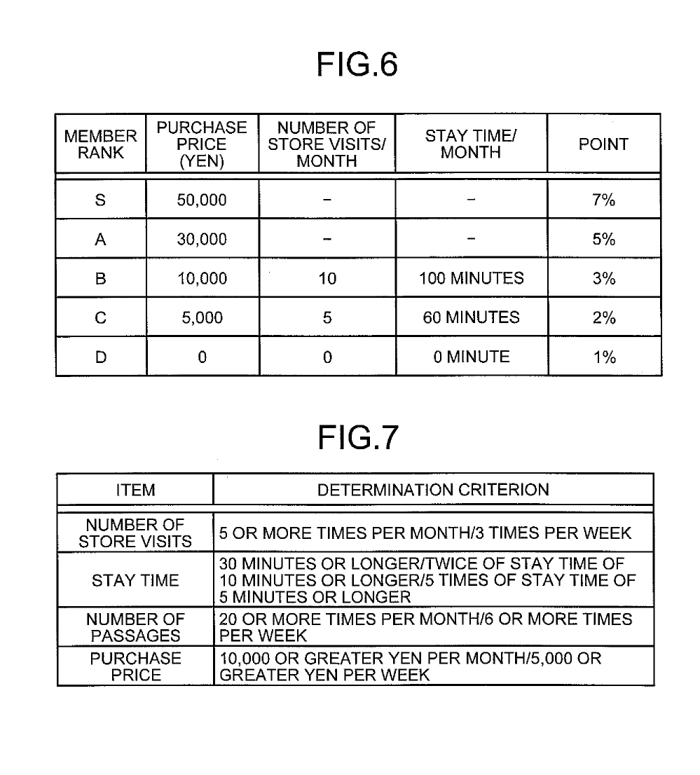

FIG. 6 is a diagram illustrating an example of a rank determination table stored in the member DB 32. As illustrated in FIG. 6, the rank determination table includes information with which information such as the “purchase price,” the “number of store visits,” the “stay time,” and the “point” is associated for each “member rank.”

In the example illustrated in FIG. 6, “S” is set as a member rank for a user of which the purchase price is equal to or greater than 50,000 yen. Further, “A” is set as a member rank for a user of which the purchase price is in the range of 30,000 yen to 49,999 yen. Further, “B” is set as a member rank for a user of which any one of the purchase price is in the range of 10,000 yen to 29,999 yen, the number of store visits is equal to or more than 10 times, or the stay time is equal to or longer than 100 minutes per month is satisfied.

“C” is set as a member rank for a user of which any one of the purchase price is in the range of 5,000 yen to 9,999 yen, the number of store visits is equal to or more than five times, or the stay time is equal to or longer than 60 minutes per month and less than 100 minutes per month is satisfied. Further, “D” is set as a member rank for a user of which the purchase price is less than 5,000 yen, the number of store visits is equal to or less than four times, and the stay time is less than 60 minutes per month are satisfied.

When the determination unit 36 determines that the enrollment of the user of the wireless terminal 5 detected by the detection unit 35 in the member service is completed, the setting unit 37 determines whether the member rank is updated based on the member data table and the rank determination table. From the fact that the member rank is related to a point or a coupon, the member rank can be efficiently updated by updating the member rank when the wireless terminal 5 enters the AP communication area.

When the enrollment process of the user of the wireless terminal 5 is completed, as described above, the setting unit 37 transmits a member automatic-registration notification to the wireless terminal 5 via the wireless LAN access point 2. The member automatic-registration notification includes the member ID or information indicating that the enrollment of the member is completed, and thus the wireless terminal 5 displays the information indicating that the enrollment of the member is completed on a display unit 52 when the wireless terminal 5 acquires the member automatic-registration notification.

The setting unit 37 also transmits a member rank change notification, an information provision notification, or the like to the wireless terminal 5 via the wireless LAN access point 2. The member rank change notification includes information indicating that the member rank is changed. The information provision notification includes, for example, information on a coupon available in the AP installation store or other information on the AP installation store.

Estimation Unit 38

Based on the interest degree determination table stored in the member DB 32, the estimation unit 38 estimates a degree of interest of user which is the degree of interest of the user of the wireless terminal 5 regarding the AP installation store. FIG. 7 is a diagram illustrating an example of the interest degree determination table.

As illustrated in FIG. 7, conditions for estimating the degree of interest of user are set in the interest degree determination table. In the example illustrated in FIG. 7, a determination criterion is set for each of the “number of store visits,” the “stay time,” the “number of passages,” and the “purchase price.” When the determination criterion is satisfied, the degree of interest of user is determined to be equal to or greater than a predetermined degree.

For example, when the number of store visits of the user to the AP installation store is equal to or more than five times per month, or is equal to or more than three times per week, the estimation unit 38 estimates that the degree of interest of user is equal to or greater than the predetermined degree. Further, when the stay time of the user in the AP installation store satisfies any one of the criterions of the stay time equal to or longer than 30 minutes, twice of the stay time equal to or longer than 10 minutes, or five times of the stay time equal to or longer than 5 minutes, the estimation unit 38 estimates that the degree of interest of user is equal to or greater than the predetermined degree.

When the number of passages of the user to the AP installation store is equal to or more than 20 times per month, or is equal to or more than six times per week, the estimation unit 38 estimates the degree of interest of user is equal to or greater than the predetermined degree. Further, When the purchase price of the user in the AP installation store is equal to or greater than 10,000 yen per month, or is equal to or greater than 5,000 yen per week, the estimation unit 38 estimates that the degree of interest of user is equal to or greater than the predetermined degree.

The determination criterions by which it is determined whether the degree of interest of user is equal to or greater than the predetermined degree are set in the interest degree determination table illustrated in FIG. 6. However, a predetermined coefficient may be applied to each of the number of store visits, the stay time, the number of passages, and the purchase price and a sum of the coefficients may be estimated as the degree of interest of user. For example, the degree of interest of user is calculated based on Formula (1) below:

Degree of interest of user=α×k1+β×k2+γ×k3+ζ×k4 (1).

In Formula (1) above, α indicates the number of store visits, β indicates the stay time, γ indicates the number of passages, and ζ indicates the purchase price. Further, k1 to k4 are the coefficients. Here, k1 to k4 can be changed for each user and other coefficients can be set according to the user attribute.

Accordingly, the estimation unit 38 can estimate the degree of interest of user regarding the AP installation store based on the number of store visits, the stay time, the number of passages, and the purchase price. Since the number of store visits, the stay time, and the number of passages are information obtainable from the detection result of the wireless terminal 5 by the wireless LAN access point 2, the estimation of the degree of interest of user can be performed with high efficiency and accuracy.

Information Providing Unit 39

When the determination unit 36 determines that the enrollment of the user of the wireless terminal 5 detected by the detection unit 35 in the member service is completed, the information providing unit 39 provides information according to the user attributes set in the member data table.

Since the store information DB 31 stores store information, advertising information, coupon information, and the like, the information providing unit 39 extracts information (hereinafter, referred to as provision information) according to the user attributes or the member rank corresponding to the user of the wireless terminal 5 from the store information DB 31 and transmits the extracted information to the wireless terminal 5 via the wireless LAN access point 2.

For example, when a user of the wireless terminal 5 is male, the information providing unit 39 extracts store information or advertising information for male as provision information from the store information DB 31. When a user of the wireless terminal 5 is female, the information providing unit 39 extracts store information or advertising information for female as provision information from the store information DB 31. Further, the information providing unit 39 can narrow down the provision information based on a purchase product, an age, an address, or the like or can extract store information or advertising information as the provision information from the store information DB 31 according to a preference of the user of the wireless terminal 5.

The information providing unit 39 can determine a timing for providing the provision information to the wireless terminal 5 based on a store visit history (the number of store visits or store visit time) or the stay time set in the member table. For example, the information providing unit 39 can provide the provision information to a user of which the number of store visits is equal to or more than a predetermined number (for example, three times) or can provide the supper information to a user of which the stay time is equal to or longer than a predetermined time (for example, 20 minutes).

Based on a history of the store visit time, the information providing unit 39 can determine the timing for providing the provision information to the wireless terminal 5. For example, when the store visit time is the same every time, the information providing unit 39 can provide the provision information to the wireless terminal 5 at a timing at which the user visits the store. Otherwise, the information providing unit 39 can provide the provision information to the wireless terminal 5 after a predetermined time passes from store visit.

The predetermined number or the predetermined time can be changed according to the user attributes. For example, the information providing unit 39 can set the predetermined number or the predetermined time to a number or a time according to the sex, the age, or the preference of the user. In this way, the provision of the information can be performed efficiently.

The information providing unit 39 can provide the wireless terminal 5 with the coupon information according to the member rank of the user of the wireless terminal 5 as the provision information. For example, the information providing unit 39 transmits information on a coupon of a larger discount rate to the wireless terminal 5 as the member rank of the user of the wireless terminal 5 is higher.

2.3. Configuration of Information Management Apparatus 4

The information management apparatus 4 includes a communication unit 41, the user information DB 42, and a control unit 43, as illustrated in FIG. 2. The control unit 43 includes a reception unit 44, a transmission unit 45, and an information management unit 46.

The communication unit 41 is an interface such as an NIC. The control unit 43 transmits and receives various kinds of information to and from the member registration apparatus 3, the information management apparatus 4, and the wireless terminal 5 via the communication unit 41.

The user information DB 42 is, for example, a storage device such as a hard disk, RAM, a semiconductor memory element such as flash memory, or an optical disc. The user information DB 42 stores information on a user, as will be described below.

The control unit 43 is realized by, for example, an integrated circuit such as an ASIC or an FPGA. Further, the control unit 43 functions as the reception unit 44, the transmission unit 45, and the information management unit 46 when a CPU or an MPU executes a program stored in an internal storage device using RAM as a working area. The configuration of the control unit 43 is not limited to the above configuration, but another configuration may be used as long as information processing to be described below can be performed.

The reception unit 44 receives a request from the member registration apparatus 3 via the communication network 6. The request from the member registration apparatus 3 is a request (hereinafter, referred to as an attribute transmission request) for transmitting the attribute information of the user, as described above, and includes the terminal ID.

The transmission unit 45 acquires the attribute information in response to the attribute transmission request received by the reception unit 44 from the user information DB 42 and transmits the acquired attribute information to the member registration apparatus 3 via the communication network 6.

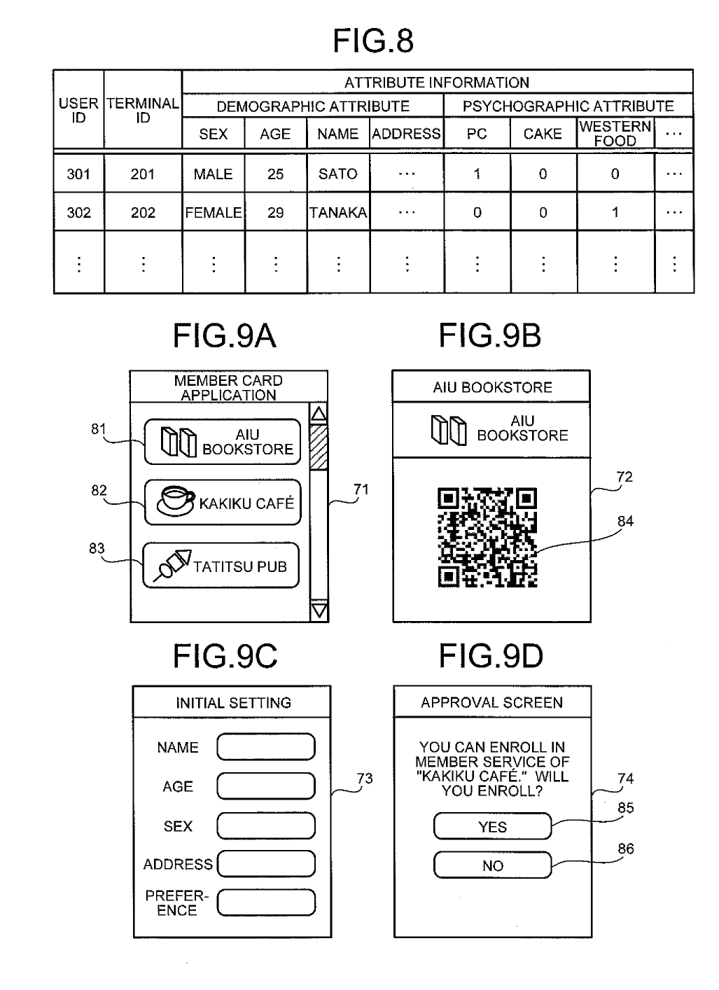

FIG. 8 is a diagram illustrating an example of a user information table stored in the user information DB 42. As illustrated in FIG. 8, the user information table includes information with which information such as the “terminal ID” and the “attribute information” is associated for each “user ID.”

The “user ID” is an ID allocated to each user of the wireless terminal 5 and is set in the user information table by the information management unit 46, for example, when user registration is performed from the wireless terminal 5 to the information management apparatus 4.

The “terminal ID” is the same ID as the terminal ID set in the terminal information table or the member data table. The “attribute information” of the user information table is extracted by the transmission unit 45 based on the terminal ID included in the attribute transmission request.

The “attribute information” is attribute information on the user of the wireless terminal 5 and includes information on a “demographics attribute” and information on a “psychographic attribute.” The “demographic attribute” is an attribute of demographics and is classified into a “sex,” an “age,” a “name,” an “address,” and the like of a user. In the example illustrated in FIG. 8, sexes, ages, names, and addresses of users are described as examples, but the invention is not limited thereto. Various classifications such as an occupation, a family, a year income, and an academic background of a user can be set as the “demographic attributes.”

The “psychographic attribute” is information indicating user's values, lifestyle, personality, preference, or the like. Here, a “personal computer,” a “cake,” “western food” and the like are classified as the “psychographic attribute,” as illustrated in FIG. 8.

In the example illustrated in FIG. 8, “1” is matched when the preference of a user is relatively high for each classification, and “0” is matched in other cases. However, the invention is not limited thereto. For example, the preference of a user may be evaluated at 3 or more stages. The classification may be modified in various ways. The attribute transmission request includes information on the classification of the user information necessary for setting the user attribute of the member data table. The attribute information according to the classification is extracted from the user information table and is transmitted to the member registration apparatus 3 by the transmission unit 45.

The information management unit 46 sets or updates the user information table. For example, the information management unit 46 sets the user information on the user of the wireless terminal 5 in the user information table when user registration of a member card application is performed from the wireless terminal 5 to the information management apparatus 4. The user registration is performed based on a user registration request from the member card application installed on the wireless terminal 5, as will be described below.

The user information table illustrated in FIG. 8 is described as a user information table for the member card app, but the user information table is not limited to the table for the member card app. For example, the user information table may be a user information table of another network service such as a social networking service (SNS), a music delivery service, a moving image delivery service, or a network game service.

Data of a member card application program is also stored in the user information DB 42. When a request for transmitting the member card application is given from the wireless terminal 5, the information management unit 46 acquires the data of the member card application program from the user information DB 42 and transmits the acquired data to the wireless terminal 5 via the communication network 6.

2.4. Configuration of Wireless Terminal 5

As illustrated in FIG. 2, the wireless terminal 5 includes a wireless LAN unit 51, a display unit 52, an operation unit 53, a storage unit 54, and a control unit 55. The wireless LAN unit 51 transmits and receives information to and from the wireless LAN access point 2.

The display unit 52 is a touch panel type display. The user of the wireless terminal 5 can operate an operation screen of the member card application displayed on the display unit 52 by operating a screen of the display unit 52 with his or her finger or the like. When the wireless terminal 5 is a smartphone, the display unit 52 is, for example, a small-sized liquid crystal display (LCD) or an organic EL display. Further, the wireless terminal 5 is not limited to the smartphone. For example, the wireless terminal 5 may be a tablet type terminal or a desktop type terminal.

The operation unit 53 includes a power button and a keyboard having keys for inputting characters, numerals, and spaces, an enter key, and a cursor key.

The storage unit 54 is, for example, a storage device such as RAM, a semiconductor memory element such as flash memory, a hard disk, or an optical disc. The storage unit 54 stores various kinds of programs, setting data, and the like. Examples of the program stored in the storage unit 54 include an operating system (OS) and a browser program. Further, the storage unit 54 also stores the member card application program acquired from the information management apparatus 4.

The control unit 55 is realized by, for example, an integrated circuit such as an ASIC or an FPGA. Also, the control unit 55 realizes or executes an information processing function or operation to be described below, for example, when a CPU, an MPU, or the like executes a program stored in the storage unit 54 using internal RAM (not illustrated) as a working area.

The control unit 55 functions as a display control unit 61, a conversion unit 62, and an information management unit 63 by executing the member card application program stored in the storage unit 54. Also, the control unit 55 stores setting data of the member card application by executing the member card application program stored in the storage unit 54 in the storage unit 54. The configuration of the control unit 55 is not limited to the above configuration and another configuration may be used as long as information processing to be described below can be performed.

The display control unit 61 generates a display image of the member card application based on the setting data stored in the storage unit 54 and displays the display image on the display unit 52. The setting data includes image data and layout data for generating the display screen. Thus, the display control unit 61 generates the display screen based on the data. FIGS. 9A to 9D are diagrams illustrating an example of the display screen of the member card application.

FIG. 9A is a diagram illustrating an example of a display screen 71 of the member card application. Member card images 81 to 83 for selecting respective member cards of a plurality of AP installation stores are displayed. In the example illustrated in FIG. 9A, the member card images 81 to 83 regarding three AP installation stores, “AIU bookstore,” “KAKIKU café,” and “TATITSU pub,” can be selected.

The conversion unit 62 performs a conversion process based on operation information output from the display unit 52. For example, the member card image 81 is assumed to be selected through a user's operation on the display unit 52 or the operation unit 53 when the display screen 71 is displayed on the display unit 52. In this case, the conversion unit 62 reads the member ID corresponding to the member card image 81 in the setting data stored in the storage unit 54 and converts the member ID into a two-dimensional barcode.

FIG. 9B is a diagram illustrating an example of a display screen 72 of the member card application. As illustrated in FIG. 9B, the display control unit 61 displays the display screen 72 containing a two-dimensional barcode 84 converted by the conversion unit 62 on the display unit 52. The user of the wireless terminal 5 can receive a member service by showing the two-dimensional barcode 84 corresponding to the member ID displayed on the display unit 52 to a store staff.

When the user activates the member card application and the attribute information regarding the user of the wireless terminal 5 is not included in the setting data stored in the storage unit 54, the display control unit 61 displays a display screen 73 illustrated in FIG. 9C on the display unit 52 and urges the user of the wireless terminal 5 to input the attribute information.

When the display screen 73 is displayed on the display unit 52 and the attribute information is input from the operation unit 53 by the user, the information management unit 63 stores the input attribute information as setting data in the storage unit 54. Also, the information management unit 63 transmits user information including the input attribute information to the information management apparatus 4 via the wireless LAN unit 51. The user information transmitted to the information management apparatus 4 includes the terminal ID. The information management apparatus 4 sets the user information transmitted from the wireless terminal 5 in the user information table.

The information management unit 63 acquires the user ID transmitted from the information management apparatus 4 in response to the transmission of the user information and stores the user ID as setting data in the storage unit 54. Also, when the member ID is transmitted from the member registration apparatus 3, the information management unit 63 stores the member ID as setting data in the storage unit 54 in association with the corresponding member card image.

When an approval query notification is received from the member registration apparatus 3, the display control unit 61 displays, for example, an approval screen 74 illustrated in FIG. 9D on the display unit 52. An approval button 85 and an approval rejection button 86 are disposed on the approval screen 74. The information management unit 63 determines which button is selected between the approval button 85 and the approval rejection button 86 by the user based on information on an operation output from the display unit 52 through a user's operation.

When the information management unit 63 determines that the approval button 85 is selected, the information management unit 63 transmits an approval notification to the member registration apparatus 3. Conversely, when the information management unit 63 determines that the approval rejection button 86 is selected, the information management unit 63 transmits an approval rejection notification to the member registration apparatus 3. Also, when the approval screen 74 is displayed on the display unit 52 and the button 85 or 86 is not selected even after elapse of a predetermined time, the information management unit 63 transmits the approval rejection notification to the member registration apparatus 3.

When approval corresponding to the member card images 81 to 83 for the user of the wireless terminal 5 is set in the storage unit 54 by the user and an approval query notification is received from the member registration apparatus 3, the information management unit 63 can transmit an approval notification to the member registration apparatus 3.

### 3. Processing Flow of Member Registration Apparatus 3

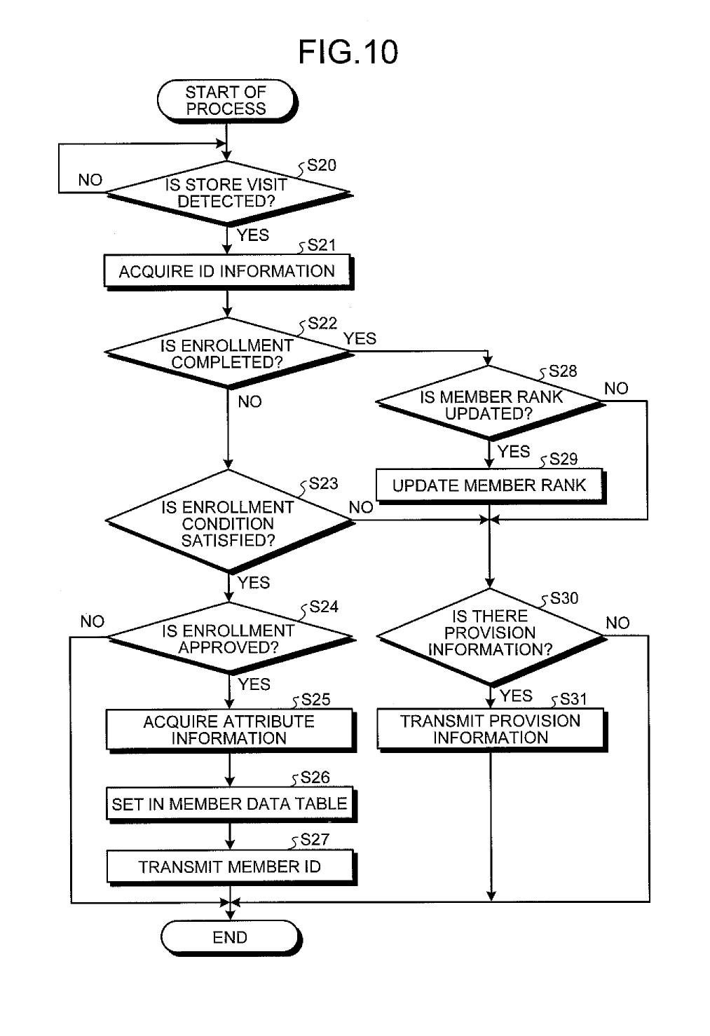

Next, a sequence of the member registration process performed by the member registration apparatus 3 according to the embodiment will be described. FIG. 10 is a flowchart of the member registration process performed by the member registration apparatus 3 according to the embodiment.

As illustrated in FIG. 10, the control unit 34 of the member registration apparatus 3 determines whether the user of the wireless terminal 5 visits the AP installation store based on the terminal information acquired from the wireless LAN access point 2 via the communication unit 33 (step S20). Specifically, the control unit 34 determines that the user of the wireless terminal 5 visits the store based on the information set in the terminal information table, for example, when the wireless terminal 5 enters the AP communication area and a predetermined time then passes.

When a radio wave intensity of the wireless terminal 5 entering the AP communication area is within a predetermined value, the control unit 34 can also determine that the user of the wireless terminal 5 visits the store. Accordingly, only when the wireless terminal 5 enters a predetermined range (hereinafter referred to a specific range) of the AP installation store, the control unit 34 can determine that the user of the wireless terminal 5 visits the store.

Only when the wireless terminal 5 enters the specific range and a predetermined time passes, the control unit 34 can also determine that the user of the wireless terminal 5 visits the store. Also, the control unit 34 can also change the specific range or the predetermined time according to the wireless terminal 5 or a period of time.

When the control unit 34 determines that the user of the wireless terminal 5 visits the AP installation store (Yes in step S20), the control unit 34 acquires ID information (step S21). Here, the control unit 34 acquires the terminal ID of the wireless terminal 5 as the ID information. However, the member ID may be acquired as the ID information from the wireless terminal 5.

Next, the control unit 34 determines whether the enrollment of the user of the wireless terminal 5 in a member service of the AP installation store is completed (step S22). Specifically, when the member information including the terminal ID acquired in step S21 is set in the member data table of the member DB 32, the control unit 34 determines that the enrollment of the user of the wireless terminal 5 in the member service is completed.

For example, when the terminal ID acquired in step S21 is “201,” the member information including the member ID “101” can be associated with the terminal ID, and thus it is determined that the enrollment of the user of the wireless terminal 5 in the member service is completed. Also, when the member ID is transmitted from the wireless terminal 5 and the member information including the member ID is set in the member data table of the member DB 32, the determination unit 36 determines that the enrollment of the user of the wireless terminal 5 in the member service is completed.

When it is determined that the enrollment of the user of the wireless terminal 5 in the member service of the AP installation store is not completed (No in step S22), the control unit 34 determines whether the enrollment condition is satisfied (step S23). Specifically, the control unit 34 estimates the degree of interest of user according to the user of the wireless terminal 5 and determines whether the estimated degree of interest of user satisfies the enrollment condition.

When the degree of interest of user satisfies the enrollment condition (Yes in step S23), the control unit 34 determines whether approval of the enrollment is obtained from the user of the wireless terminal 5 (step S24). When the control unit 34 transmits an approval query notification to the wireless terminal 5 and receives an approval notification in response to the approval query notification, the control unit 34 determines that the approval of the enrollment is obtained. When the control unit 34 receives an approval rejection notification from the wireless terminal 5 in response to the approval query notification, the control unit 34 determines that the approval of the enrollment is not obtained.

When the control unit 34 determines that the approval of the enrollment is obtained (Yes in step S24), the control unit 34 acquires the attribute information of the user of the wireless terminal 5 from the information management apparatus 4 (step S25). Specifically, the control unit 34 requests the information management apparatus 4 to transmit the attribute information of the user of the wireless terminal 5 via the communication network 6. The request includes the terminal ID of the wireless terminal 5. The information management apparatus 4 is required to transmit the attribute information corresponding to the terminal ID.

When the control unit 34 acquires the attribute information corresponding to the terminal ID of the wireless terminal 5 from the information management apparatus 4, the control unit 34 sets the attribute information and a newly allocated member ID in the member data table of the member DB 32 by associating the attribute information and the newly allocated member ID with the terminal ID of the wireless terminal 5 (step S26). The new member ID is allocated to the user satisfying the enrollment condition by the control unit 34.

Next, the control unit 34 performs the member automatic-registration notification on the wireless terminal 5. Specifically, the control unit 34 transmits the new member ID allocated in step S26 and information indicating that the member registration is completed to the wireless terminal 5 (step S27). The control unit 55 of the wireless terminal 5 displays the information indicating that the member registration is completed on the display unit 52, using the member card application. Also, the control unit 55 of the wireless terminal 5 sets the member ID acquired from the member registration apparatus 3 in the setting data of the storage unit 54. The setting data includes the member ID and the member card image for each member service of the AP installation store, and thus the control unit 34 reads the member ID corresponding to the selected member card image from the storage unit 54, and converts the member ID into the two-dimensional barcode 84, and displays the two-dimensional barcode on the display unit 52.

When the control unit 34 determines in step S22 that the enrollment of the user of the wireless terminal 5 for the member service of the AP installation store is completed (Yes in step S22), the control unit 34 determines whether the member rank is updated based on the member data table and the rank determination table (step S28).

When the member rank higher than the member rank set in the member data table is satisfied, the control unit 34 determines that member rank of the member data table is updated (Yes in step S28) and updates the member rank of the user of the wireless terminal 5 in the member data table (step S29). When the member rank is changed, the control unit 34 transmits a member rank change notification to the wireless terminal 5.

When the process of step S29 ends and it is determined that the member rank is not updated (No in step S28) or it is determined that the enrollment condition is not satisfied (Yes in step S23), the control unit 34 transfers the process to step S30.

In step S30, the control unit 34 determines whether there is information to be supplied to the wireless terminal 5. For example, at a timing at which the provision information is supplied to the wireless terminal 5, the control unit 34 determines that there is the information to be supplied to the wireless terminal 5 based on the store visit history or the stay time of the user of the wireless terminal 5.

When the control unit 34 determines that there is the information to be supplied to the wireless terminal 5 (Yes in step S30), the control unit 34 performs an information provision notification. Specifically, the control unit 34 acquires the user attribute or the member rank regarding the user of the wireless terminal 5 from the member data table, and extracts information according to the acquired user attribute or the acquired member rank from the store information DB 31, and transmits the extracted information to the wireless terminal 5 (step S31).

When the processes of step S27 and S31 end, the approval of the enrollment is not obtained (No in step S24), and when it is determined that there is no information to be supplied to the wireless terminal 5 (No in step S30), the control unit 34 ends the member registration process.

### 4. Modification Examples

In the above-described embodiment, the member registration apparatus 3 and the information management apparatus 4 have separately been described, but the functions of the information management apparatus 4 may be included in the member registration apparatus 3.

The example has been described above in which the terminal ID or the member ID is transmitted as the ID information to be transmitted from the wireless terminal 5 to the member registration apparatus 3. However, the user ID may be transmitted as the ID information from the wireless terminal 5 to the member registration apparatus 3.

Specifically, the information management unit 63 of the wireless terminal 5 acquires the user ID included in the setting data from the storage unit 54 and transmits the user ID to the member registration apparatus 3. The control unit 34 of the member registration apparatus 3 transmits, to the information management apparatus 4, the attribute transmission request including the user ID transmitted from the wireless terminal 5. The control unit 43 of the information management apparatus 4 extracts the attribute information regarding the user ID included in the attribute transmission request from the user information table and transmits the extracted user information to the member registration apparatus 3.

In the above-described embodiment, the terminal ID or the member ID has been transmitted from the wireless terminal 5 to the member registration apparatus 3 and the member registration apparatus 3 has acquired the attribute information of the user of the wireless terminal 5 from the information management apparatus 4. However, a method of acquiring the attribute information is not limited to the above method.

For example, the control unit 34 of the member registration apparatus 3 requests the wireless terminal 5 of the user satisfying the enrollment condition although is not registered in the member service to transmit the attribute information. The information management unit 63 of the wireless terminal 5 extracts the attribute information from the setting data stored in the storage unit 54 and transmits the attribute information to the member registration apparatus 3, when the attribute information is requested from the member registration apparatus 3. The member registration apparatus 3 sets the attribute information acquired from the wireless terminal 5 to the member data table and performs member registration of the user of the wireless terminal 5.

### 5. Advantages

As described above, the member registration system 1 according to the embodiment includes the wireless LAN access point 2 (corresponding to an example of a wireless communication apparatus), the member DB 32 that stores the information of a member service of the store in which the wireless LAN access point 2 is installed, and the information processing apparatus 30 that performs the enrollment process in the member service. The detection unit 35 (corresponding to an example of a detection unit) of the information processing apparatus 30 detects the wireless terminal 5 present within the communication area of the wireless LAN access point 2. The determination unit 36 (corresponding to an example of a determination unit) determines whether the enrollment of the user of the wireless terminal 5 detected by the detection unit 35 in the member service is completed based on the information stored in the member DB 32. The setting unit 37 (corresponding to an example of a setting unit) registers the information on the user of the wireless terminal 5 as the member information of the member service in the member DB 32, when the user of the wireless terminal 5 for which the determination unit 36 determines that the enrollment in the member service is not completed, is a user satisfying a preset enrollment condition.

In the member registration system 1, the enrollment process in the member service can be performed without user's time and effort and it is not necessary that the store side manually register the user information in the member DB 32 either. Also, the enrollment process in the member service is performed when the preset enrollment condition is satisfied. Thus, reduction in a processing load or suppression of an increase in a DB capacity can be achieved compared to a case in which the enrollment process is performed every time on the wireless terminal 5 entering the AP communication area.

In the member registration system 1 according to the embodiment, the estimation unit 38 (corresponding to an example of an estimation unit) of the information processing apparatus 30 estimates the degree of interest of the user of the wireless terminal 5 with respect to the AP installation store. When the degree of interest estimated by the estimation unit 38 satisfies the enrollment condition, the setting unit 37 registers the information on the user of the wireless terminal 5 as the member information of the member service in the member DB 32.

In the member registration system 1, the member registration is performed based on the degree of interest with respect to the AP installation store, and thus the member registration of a user less interested in the AP installation store can be avoided. Also, the reduction in a processing load or the suppression of an increase in a DB capacity can be achieved compared to a case in which the enrollment process is performed every time on the wireless terminal 5 entering the AP communication area.

In the member registration system 1 according to the embodiment, the estimation unit 38 estimates the degree of interest of the user with respect to the AP installation store based on at least one of the stay time of the user in the AP installation store, the store visit history of the user to the AP installation store, the purchase history of the user in the AP installation store, and the passage history of the wireless terminal 5 in the AP communication area.

In the member registration system 1, the degree of interest of the user with respect to the AP installation store can be estimated with high accuracy. Thus, the member registration of a user less interested in the AP installation store can be avoided with high accuracy.

In the member registration system 1 according to the embodiment, the estimation unit 38 acquires the stay time, the store visit history, or the passage history described above based on the detection result of the wireless terminal 5 by the detection unit 35.

In the member registration system 1, it is possible to efficiently acquire the information from the detection result of the wireless terminal 5 by the wireless LAN access point 2. Also, it is possible to acquire the stay time, the store visit history, or the passage history rapidly and with high accuracy.

In the member registration system 1 according to the embodiment, the setting unit 37 sets the member rank in the member DB 32 based on the degree of interest estimated by the estimation unit 38. The information providing unit 39 (corresponding to an example of an information providing unit) provides the wireless terminal 5 with the information according to the member rank set in the member DB 32 via the wireless LAN access point 2.

In the member registration system 1, it is possible to provide the suitable information according to the member rank to the user of the wireless terminal 5. Promotion can be achieved by providing coupon information of a larger discount rate to the user with a high member rank and providing a plurality of pieces of coupon information divided for each period to a user with a low member rank.

In the member registration system 1 according to the embodiment, the setting unit 37 queries enrollment approval to the wireless terminal 5 when the user of the wireless terminal 5 satisfies the preset enrollment condition, and registers the information on the user of the wireless terminal 5 as the member information of the member service in the member DB 32 when the enrollment approval is obtained in response to the query.

In the member registration system 1, the enrollment process is performed when the approval of the user of the wireless terminal 5 is obtained. Therefore, the enrollment of a user who does not desire the enrollment process is omitted, and the processing load is reduced. On the other hand, an unintended enrollment process can be avoided for the user of the wireless terminal 5.

In the member registration system 1 according to the embodiment, the setting unit 37 acquires the information on the user of the wireless terminal 5 from the user information DB 42 storing the information on the user of the wireless terminal 5 and registers the information in the member DB 32.

In the member registration system 1, the user information can be acquired easily. For example, since the user information DB 42 is configured as the member data table for the member card application and the user information is set at the time of the user registration of the member card application, therefore the enrollment process in member services of a plurality of AP installation stores can be performed easily.

In the member registration system 1 according to the embodiment, the information management apparatus 4 (corresponding to an example of the program delivery apparatus) delivers data of a member card application program (corresponding to an example of a store member program) to the wireless terminal 5. The control unit 34 (corresponding to an example of a member ID processing unit) of the information processing apparatus 30 allocates a member ID to the user of the wireless terminal 5 and transmits the allocated member ID to the wireless terminal 5. The member card application program causes the wireless terminal 5 to function as the storage unit 54 (corresponding to an example of a member information storage unit) that stores the member ID transmitted from the information processing apparatus 30, the conversion unit 62 (corresponding to an example of a conversion unit) that converts the member ID stored in the storage unit 54 into a barcode, and the display control unit 61 (corresponding to an example of a display processing unit) that displays the barcode converted by the conversion unit 62 on the display unit 52 of the wireless terminal 5.

In the member registration system 1, the barcode easily enables application to a store providing a member card. The example of the two-dimensional barcode 84 has been described as the barcode, but a one-dimensional barcode may be used.

According to the embodiment, it is possible to provide a member registration system, a member registration apparatus, and a member registration method capable of performing an enrollment process in a member service of a store without a load on the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A member registration system comprising:
a wireless communication apparatus;
an information processing apparatus that performs a process of enrollment in a member service of a store in which the wireless communication apparatus is installed; and
a member database that stores member information of the member service,
wherein the information processing apparatus includes
a detection unit configured to detect a wireless terminal present within a communication area of the wireless communication apparatus,
a determination unit configured to determine whether enrollment of a user of the wireless terminal detected by the detection unit in the member service is completed based on information stored in the member database, and
a setting unit configured to register information on the user of the wireless terminal as member information of the member service in the member database, when the user of the wireless terminal for which the determination unit determines that the enrollment in the member service is not completed is a user satisfying a preset enrollment condition.

2. The member registration system according to claim 1,
wherein the information processing apparatus further includes an estimation unit configured to estimate the degree of interest of the user of the wireless terminal with respect to the store, and
wherein the setting unit registers the information on the user of the wireless terminal as member information of the member service in the member database, when the degree of interest estimated by the estimation unit satisfies the enrollment condition.

3. The member registration system according to claim 2, wherein the estimation unit estimates the degree of interest of the user with respect to the store based on at least one of a stay time of the user in the store, a visit history to the store, a purchase history in the store, and a passage history of the wireless terminal in the communication area.

4. The member registration system according to claim 3, wherein the estimation unit acquires the stay time, the visit history, or the passage history based on a result of the detection of the wireless terminal by the detection unit.

5. The member registration system according to claim 2,
wherein the setting unit sets a member rank in the member database based on the degree of interest estimated by the estimation unit, and
wherein the information processing apparatus further includes an information providing unit configured to provide information according to the member rank set in the member database to the wireless terminal via the wireless communication apparatus.

6. The member registration system according to claim 1, wherein the setting unit queries enrollment approval to the wireless terminal when the user of the wireless terminal is a user satisfying the preset enrollment condition, and registers the information on the user of the wireless terminal as the member information of the member service in the member database when the enrollment approval is obtained from the user of the wireless terminal in response to the query.

7. The member registration system according to claim 1, further comprising:
a user information database that stores the information on the user of the wireless terminal,
wherein the setting unit acquires the information on the user of the wireless terminal from the user information database and registers the information in the member database.

8. The member registration system according to claim 1, further comprising:
a program delivery apparatus that delivers data of a store member program to the wireless terminal,
wherein the information processing apparatus further includes
a member ID processing unit configured to allocate a member ID to the user of the wireless terminal and to transmit the allocated member ID to the wireless terminal,
wherein the store member program causes the wireless terminal to function as
a member information storage unit that stores the member ID transmitted from the information processing apparatus,
a conversion unit that converts the member ID stored in the member information storage unit into a barcode, and
a display control unit that displays the barcode converted by the conversion unit on a display unit of the wireless terminal.

9. A member registration apparatus comprising:
a detection unit configured to detect a wireless terminal present within a communication area of a wireless communication apparatus;
a determination unit configured to determine whether enrollment of a user of the wireless terminal detected by the detection unit in a member service of a store in which the wireless communication apparatus is installed is completed based on information of a member database storing member information of the member service; and
a setting unit configured to register information on the user of the wireless terminal as the member information of the member service in the member database, when the user of the wireless terminal for which the determination unit determines that the enrollment in the member service is not completed is a user satisfying a preset enrollment condition.

10. A member registration method performed by a computer, comprising:
detecting a wireless terminal present within a communication area of a wireless communication apparatus;
determining whether enrollment of a user of the wireless terminal, which is detected in the detecting, in a member service of a store in which the wireless communication apparatus is installed is completed based on information of a member database storing member information of the member service; and
registering information on the user of the wireless terminal as the member information of the member service in the member database, when the user of the wireless terminal for which it is determined in the determining that the enrollment in the member service is not completed is a user satisfying a preset enrollment condition.
